(19) United States
(12) Patent Application Publication
(10) Pub. No.: US 2023/0309600 A1
(43) Pub. Date: Oct. 5, 2023

(54) Multi-Functional Food Processing Machine

(71) Applicant: Chaojing Weng, Greenwell Springs, LA (US)

(72) Inventor: Chaojing Weng, Greenwell Springs, LA (US)

(21) Appl. No.: 17/712,367

(22) Filed: Apr. 4, 2022

(51) Int. Cl. A23N 15/12; A23N 12/06; A23P 20/12; B26D 1/38

(52) U.S. Cl. CPC A23N 15/12; B26D 1/38; A23P 20/12; A23N 12/06

(57) ABSTRACT

A multi-functional food processing machine suitable for processing green beans or any other suitable ingredient is presented. The multi-functional food processing machine contains a tumbler chassis, a tumbler drum, a motor, and a cutting element. The tumbler chassis contains an inlet hopper, and an outlet spout. The tumbler drum contains a plurality of gaps and a plurality of tumbler fins. The motor is torsionally engaged to the tumbler drum. The plurality of gaps is peripherally distributed about the tumbler drum. The plurality of tumbler fins is peripherally connected within the tumbler drum. The inlet hopper traverses into the tumbler drum. The outlet spout traverses from the tumbler drum to the tumbler chassis, opposite to the inlet hopper. The cutting element is operatively engaged to the tumbler drum, where the cutting element is configured to cut bean tips that passes through the plurality of gaps.

### FIELD OF THE INVENTION

The present invention relates to processing machines. More specifically, the present invention is a multi-functional food processing machine.

### BACKGROUND OF THE INVENTION

Beans, such as green beans, as harvested have a central edible pod with blossom and stem ends which are fibrous and non-tender. These ends have a low palatability and are shunned by the consumers of the beans. Therefore, prior to canning and marketing beans it is essential to remove as many of the stem and blossom ends as possible. Specialized machines known as bean snippers have long been used to remove the ends from a flow of beans prior to canning or packaging. A conventional bean snipper has a rotatable drum formed from a number of cylindrical shell sections with slots extending circumferentially. The slots are adapted to allow the ends of beans to protrude as they tumble in the rotating drum. Knives sliding on the rotating exterior of the cylindrical sections cut off the protruding undesirable blossom and stem ends. Axially spaced partitions within the drum are adapted to maximize the likelihood that pods being processed in the drum will enter the slots so that the bean ends will protrude through the slots for snipping. A passageway in each partition allows the beans to migrate down the length of the rotating drum when the drum is elevated at one end.

Invariably stalks, leaves, malformed beans, and other unpalatable or otherwise undesirable trash is harvested along with the beans. To present the bean consumer with pure beans uncontaminated by such trash, it is desirable to separate the undesirable refuse from the desired beans. In addition, conventional systems are dedicated bean snipping systems and lack further ingredient processing modularity. Therefore, it is an objective of the present invention to solve these limitations and problems.

The present invention facilitates ample bean snipping and processing, allowing a user to process unprocessed beans by separating undesirable refuse from the desirable bean ingredient. In addition, the present invention features a modular ingredient processing system that can be utilized for a variety of ingredients not limited to green beans such as but not limited to mushrooms, meat, vegetables, or any other suitable ingredient. The present invention features interchangeable toolheads, allowing the user to wash the processed ingredients thoroughly, further removing dirt, debris, and other undesirable refuse. Furthermore, the present invention facilitates a tumble-drying means of centrifuging any excess water from the processed ingredients. Additionally, the present invention contains access ports, allowing the user to insert sauce receptacles such that the present invention serves as a sauce tumbler. Furthermore, the present invention features a sift style toolhead, working in conjunction with a vibrator, such that the present invention also serves as a breading sifter for battered and breaded ingredients.

### SUMMARY OF THE INVENTION

The present invention is a multi-functional food processing machine suitable for a multitude of food-prep tasks. The multi-functional food processing machine comprises a tumbler chassis, a tumbler drum, a motor, and a cutting element. The tumbler chassis comprises a tumbler track, a tumbler roller, an inlet hopper, and an outlet spout. The tumbler drum comprises a drum cavity, a plurality of gaps, and a plurality of tumbler fins. The tumbler track is connected within the tumbler chassis. The tumbler drum is rotatably connected to the tumbler track. The tumbler roller is rotatably engaged to the tumbler drum. The motor is torsionally engaged to the tumbler roller. The drum cavity is positioned within the tumbler drum. The plurality of gaps is peripherally distributed about the tumbler drum. The plurality of tumbler fins is peripherally connected about the drum cavity. The inlet hopper traverses from the tumbler chassis to the drum cavity. The outlet spout traverses from the drum cavity to the tumbler chassis, opposite to the inlet hopper. The cutting element is operatively engaged to the tumbler drum, where the cutting element is configured to skim tangent along the tumbler drum.

### BRIEF DESCRIPTION OF THE DRAWINGS

FIG. 1 is a top-right perspective view of the present invention.

FIG. 2 is a top-left perspective view of the present invention.

FIG. 3 is a top-right perspective exploded view of the present invention.

FIG. 4 is a top-rear perspective exploded view of the present invention.

FIG. 5 is a top view of the present invention.

FIG. 6 is a cross sectional view of the present invention taken along cutting lines B-B in

FIG. 5.

FIG. 7 is a top-right perspective view of the present invention that shows an interchangeable sift tray.

FIG. 8 is a bottom-right perspective view of the present invention that shows the interchangeable sift tray.

FIG. 9 is a top-right perspective view of the present invention that shows an interchangeable washing unit.

FIG. 10 is a bottom-right perspective view of the present invention that shows the interchangeable washing unit.

FIG. 11 is a circuit diagram used in the present invention.

FIG. 12 is a top view of the present invention, in accordance with another embodiment.

FIG. 13 is a cross sectional view of the present invention taken along cutting lines A-A in FIG. 12.

FIG. 14 is a detailed view of the present invention taken along circle B in FIG. 13.

FIG. 15 is a top perspective view of a toolhead used in the present invention, in accordance with another embodiment.

FIG. 16 is a bottom perspective view of the toolhead used in the present invention, in accordance with another embodiment.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

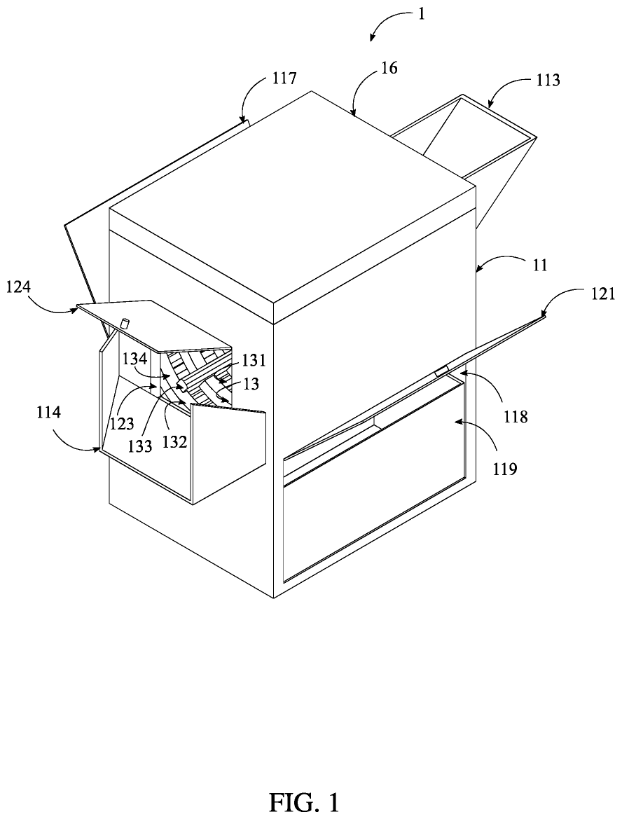

In reference to FIGS. 1-8, the present invention is a multi-functional food processing machine 1 suitable for a multitude of food-prep tasks. In reference to FIGS. 1-8 and 11, the multi-functional food processing machine 1 comprises a tumbler chassis 11, a tumbler drum 13, a motor 14, and a cutting element 15. The tumbler chassis 11 comprises a tumbler track 111, a tumbler roller 112, an inlet hopper 113, and an outlet spout 114. In reference to FIGS. 1-4 and 6, the tumbler drum 13 comprises a drum cavity 131, a plurality of gaps 132, a plurality of tumbler fins 133, and a plurality of tumbler partitions 134. The tumbler track 111 is connected within the tumbler chassis 11. The tumbler drum 13 is rotatably connected to the tumbler track 111. The tumbler roller 112 is rotatably engaged to the tumbler drum 13. The motor 14 is torsionally engaged to the tumbler roller 112. The drum cavity 131 is positioned within the tumbler drum 13. The plurality of gaps 132 is peripherally distributed about the tumbler drum 13. The plurality of tumbler fins 133 is peripherally connected about the drum cavity 131. The plurality of tumbler partitions 134 is longitudinally distributed along the drum cavity 131. The inlet hopper 113 traverses from the tumbler chassis 11 to the drum cavity 131. The outlet spout 114 traverses from the drum cavity 131 to the tumbler chassis 11, opposite to the inlet hopper 113. The cutting element 15 is operatively engaged to the tumbler drum 13, where the cutting element 15 is configured to skim tangent along the tumbler drum 13. In the preferred embodiment, the multi-functional food processing machine 1 is configured to process green beans, processing unprocessed green beans into usable ingredients. More specifically, the unprocessed green beans are fed into the inlet hopper 113 where the green beans are then directed into the tumbler drum 13. When the tumbler drum 13 is in motion, the green beans are agitated and sorted using the plurality of tumbler fins 133 such that the green bean ends slip through the plurality of gaps 132 of the tumbler drum 13 while the green bean body is caught along the plurality of gaps 132. The green bean ends are then cut off using the cutting element 15 that skims longitudinally along the tumbler drum 13. The green beans are continuously tumbled until all the green bean tips have been cut off. The green beans are then directed out of the tumbler drum 13 through the output spout where the user can then collect the processed green beans. In the preferred embodiment, the multi-functional food processing machine 1 primarily processes green beans but may also process any other suitable ingredient such as, but not limited to mushrooms, carrots, asparagus, broccoli, or any other suitable ingredient. In the preferred embodiment, the multi-functional food processing machine 1 also serves as a sauce-prep tumbler, where the user can insert a sauce receptacle within the tumbler drum 13. The rotating tumbler drum 13, in conjunction with the plurality of tumbler fins 133 will tumble and agitate the receptacle, which in turn will mix the sauce, marinade, seasoning blend, or any other blend placed within the sauce receptacle into a homogeneous and processed ingredient. In the preferred embodiment, the multi-functional food processing machine 1 also serves as a tumble dryer, where the user can place wet or washed ingredients within the rotating tumbler drum 13. Liquid articles are quickly centrifuged out of the wet or washed ingredients, seeping through the plurality of gaps 132 and out of the tumbler drum 13. In the preferred embodiment, the plurality of tumbler partitions 134 serves as tumbler dividers that aids in propping the green beans vertically along the plurality of tumbler partitions 134, allowing the green bean ends to slip through the plurality of gaps 132.

In the preferred embodiment, the tumbler chassis 11 takes the form of a rigid machine frame suitable for containing and supporting the components that constitutes the multi-functional food processing machine 1. In the preferred embodiment, the tumbler chassis 11 is made out of any suitable material such as but not limited to aluminum, stainless steel, treated lumber, polymer, or any other suitable material. In the preferred embodiment, the tumbler drum 13 serves as the primary tumbling element of the multi-functional food processing machine 1 where the tumbler drum 13 is configured to tumble, sort, dry, or process ingredients in conjunction with the cutting element 15. In the preferred embodiment, the tumbler drum 13 is made out of any suitable material such as but not limited to aluminum, stainless steel, treated lumber, polymer, or any other suitable material. In the preferred embodiment, the motor 14 takes the form of any suitable torsion driving device that provides rotational force along the tumbler drum 13. In one embodiment, the motor 14 takes the form of an electrical motor 14. In another embodiment, the motor 14 may take the form of a manual crank mechanism where the user can manually turn the tumbler drum 13. In the preferred embodiment, the cutting element 15 takes the form of a long blade fixed to the tumbler chassis 11. The cutting element 15 is oriented longitudinally to the tumbler drum 13 such that the cutting element is configured to cut articles that pass through the plurality of gaps 132.

In the preferred embodiment, the tumbler track 111 takes the form of any suitable rotational track element that rotatably connects the tumbler drum 13 to the tumbler chassis 11. In one embodiment, the tumbler track 111 is a plurality of rollers that rotatably connects the tumbler drum 13 along the tumbler chassis 11. In various embodiments, the tumbler track 111 may take the form of any other suitable rotational track element such as but not limited to axially connected tracks, bearing connected tracks, bushing connected tracks, or any other suitable rotational track element. In the preferred embodiment, the tumbler roller 112 takes the form of any suitable rotational transmission element that bridges the motor 14 to the tumbler drum 13, transmitting rotational force generated by the motor 14 to the tumbler drum 13. In the preferred embodiment, the tumbler roller 112 takes the form of a friction driven roller that engages along the tumbler drum 13. In another embodiment, the tumbler roller 112 may take the form of a pulley driven system that connects the motor 14 to the tumbler drum 13. In another embodiment, the tumbler roller 112 may take the form of a gear driven system that connects the motor 14 to the tumbler drum 13.

In the preferred embodiment, the inlet hopper 113 takes the form of an insertion chute that allows the user to feed unprocessed ingredient into the tumbler drum 13. More specifically, the inlet hopper 113 takes the form of a gravity fed media hopper that directs unprocessed ingredients into the tumbler drum 13. In the preferred embodiment, the outlet spout 114 serves as the processed ingredient outlet port of the multi-functional food processing machine 1 where processed ingredients coming out of the tumbler drum 13 are directed out of the outlet spout 114.

In the preferred embodiment, the drum cavity 131 takes the form of the interior volume of the tumbler drum 13 where unprocessed ingredients are housed in. In the preferred embodiment, the plurality of gaps 132 takes the form of openings along the tumbler drum 13 that allows green bean tips to slip through while retaining the green bean body within the tumbler drum 13. In the preferred embodiment, the plurality of tumbler fins 133 takes the form of extruded bodies distributed radially within the tumbler drum 13. The plurality of tumbler fins 133 serves as tumbling elements that agitate the ingredients housed in the drum cavity 131 when the tumbler drum 13 is in motion.

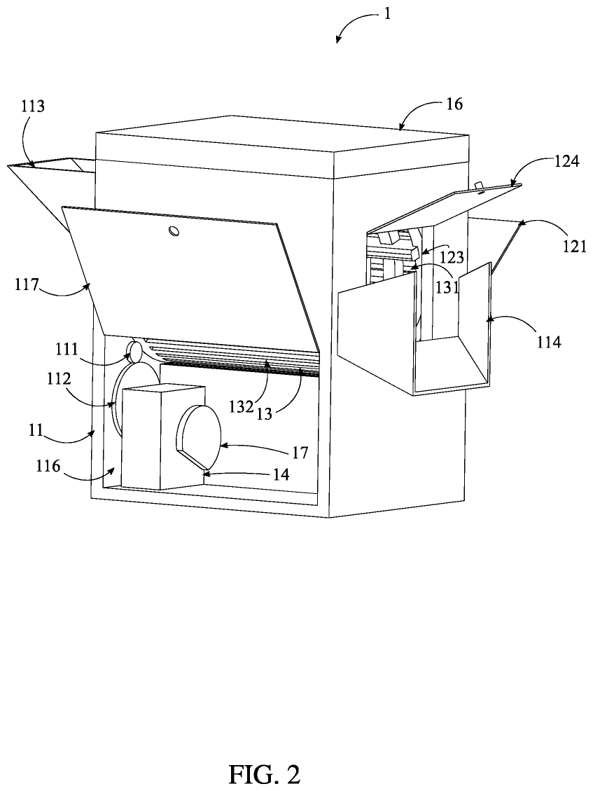

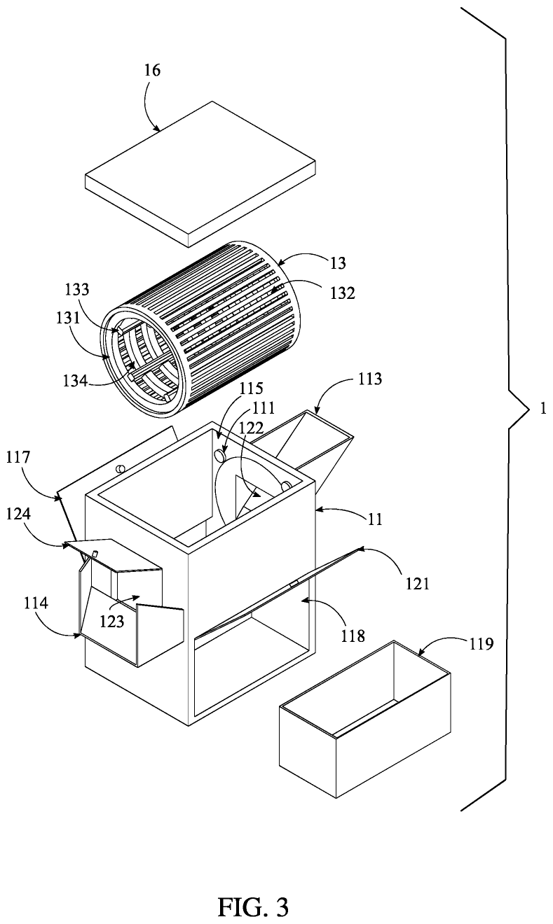

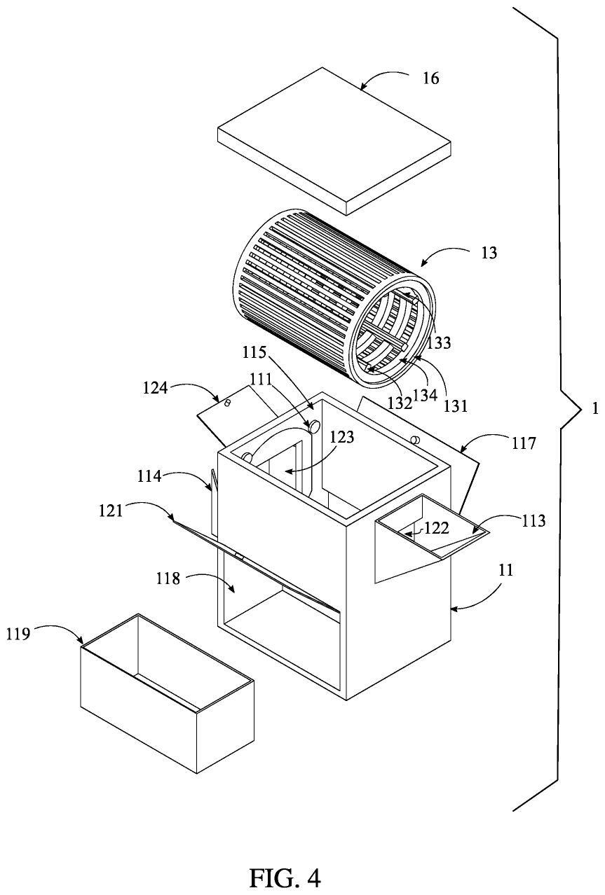

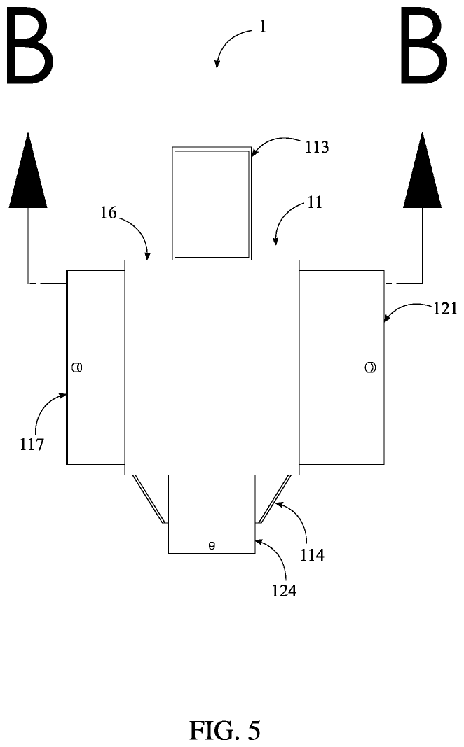

In the preferred embodiment, the multi-functional food processing machine 1 further comprises a toolhead 16, as shown in FIGS. 1-10. In reference to FIGS. 3-4, the tumbler chassis 11 comprises an upper receiver channel 115. The upper receiver channel 115 traverses from the tumbler chassis 11 to the tumbler drum 13. The toolhead 16 is connected along the upper receiver channel 115. In the preferred embodiment, the toolhead 16 takes the form of a top cover that covers the upper receiver channel 115. In another embodiment, the toolhead 16 is a sifting tray, as shown in FIGS. 7-8. The sifting tray comprises a sift channel 161 and a sifting screen 162. The sift channel 161 traverses through the sifting tray. The sifting screen 162 is delineated along the sift channel 161. The multi-functional food processing machine 1 further comprises a vibration unit 17, as shown in FIGS. 2 and 11. The vibration unit 17 is operatively engaged to the tumbler chassis 11, where the vibration unit 17 is configured to transmit vibration to the sifting tray. In this embodiment, the multi-functional food processing machine 1 serves as a sift for breaded ingredients. More specifically, the user may insert breaded ingredients on top of the sifting tray such that excess breading and flour may sift out of the breaded ingredients. In the preferred embodiment, the sift channel 161 takes the form of a raised boundary along the sifting tray such that the breaded ingredients placed on top of the sifting screen 162 are secured within the sifting tray. In the preferred embodiment, the sifting screen 162 takes the form of any suitable mesh screen suitable for sifting out excess bread and flour material from breaded ingredients. In the preferred embodiment, the vibration unit 17 takes the form of any suitable mechanical vibrator that provides ample vibration along the sifting tray.

In another embodiment, the toolhead 16 is a washing unit, as shown in FIGS. 9-10. The washing unit comprises a mounting surface 163, a water inlet 164 and a sprinkler 165. The mounting surface 163 traversing along the toolhead 16. The sprinkler 165 traverses along the mounting surface 163. The water inlet 164 is connected adjacent to the toolhead 16. The water inlet 164 is in fluid communication with the sprinkler 165. In this embodiment, the washing unit takes the form of an ingredient washing head that administers wash water to the tumbling drum. The mounting surface 163 facilitates the sprinkler 165 where the mounting surface 163 is oriented towards the tumbler drum 13. The water inlet 164 serves as the wash water inlet 164 port that allows the user to connect and support a water supply along the washing unit. The sprinkler 165 takes the form of a shower bulkhead that longitudinally applies a shower stream of water to the tumbler drum 13.

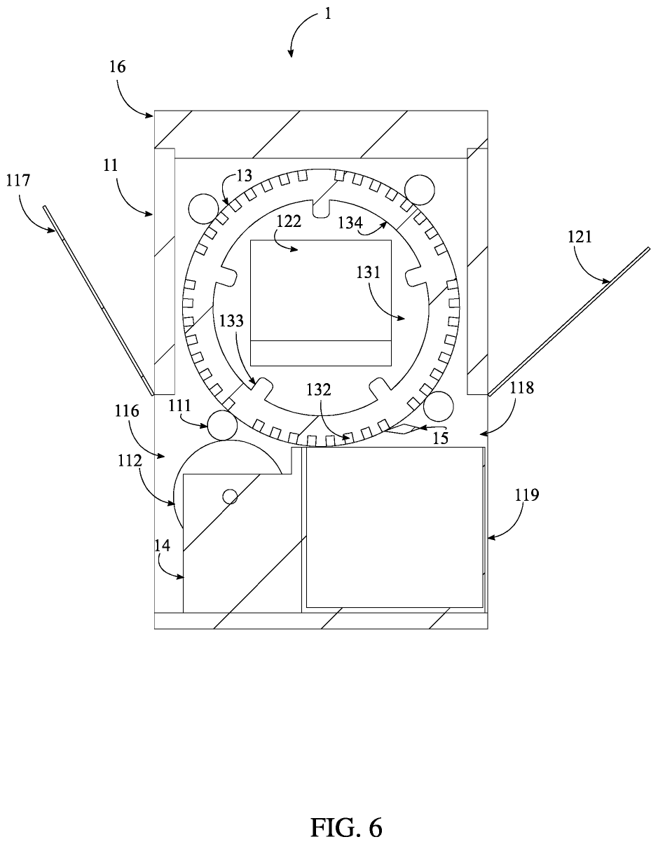

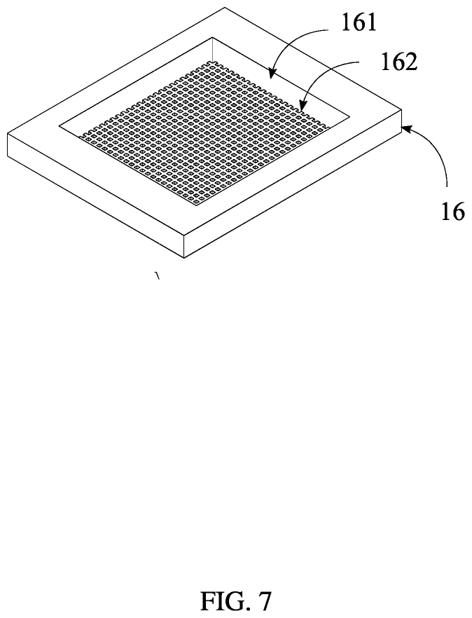

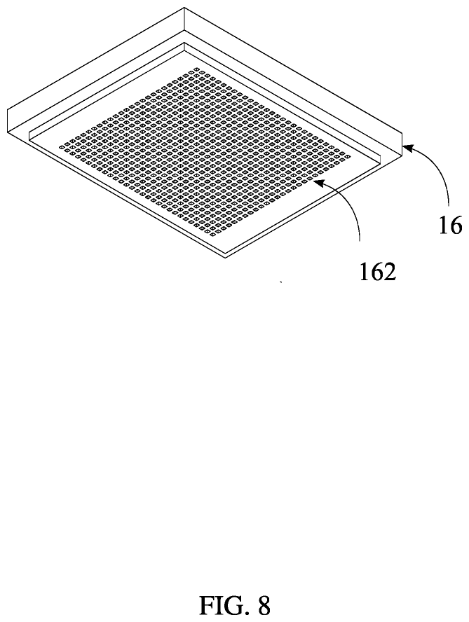

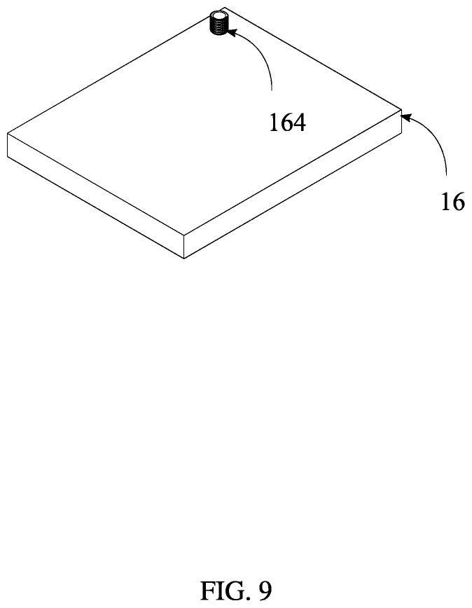

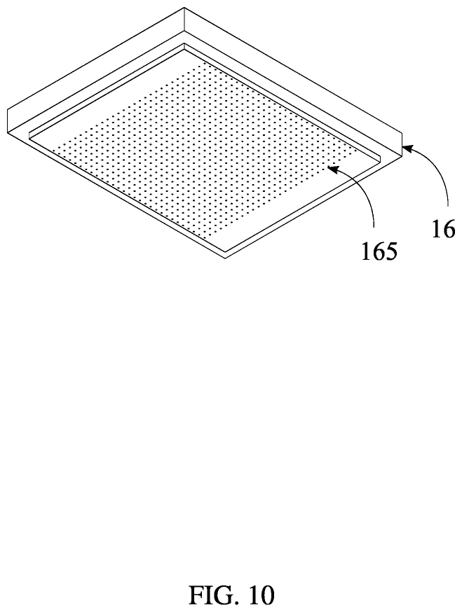

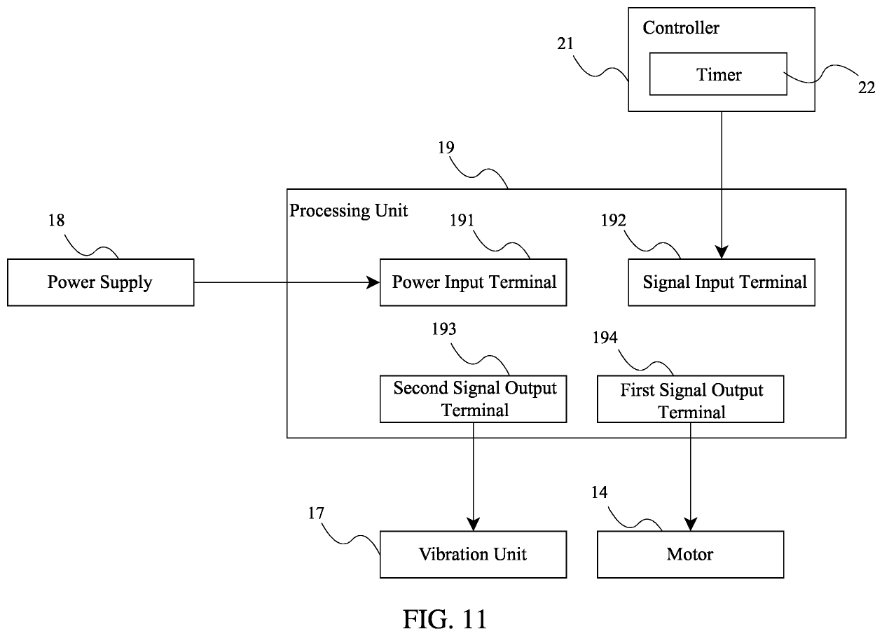

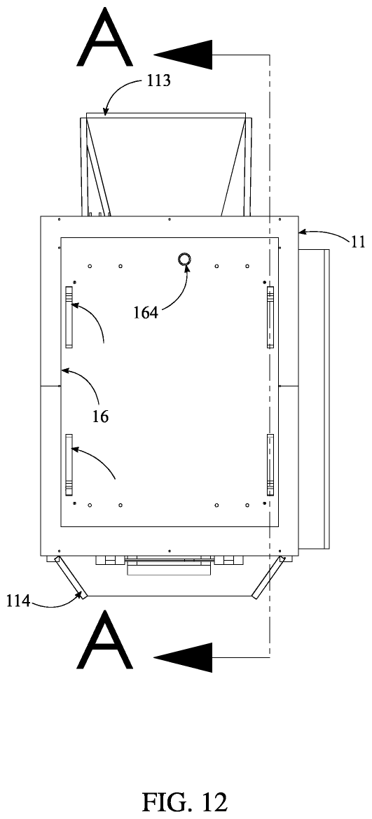

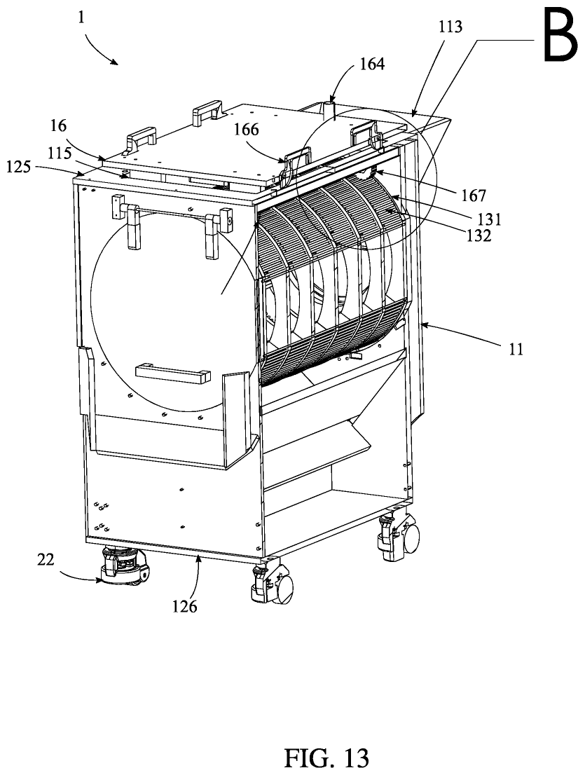

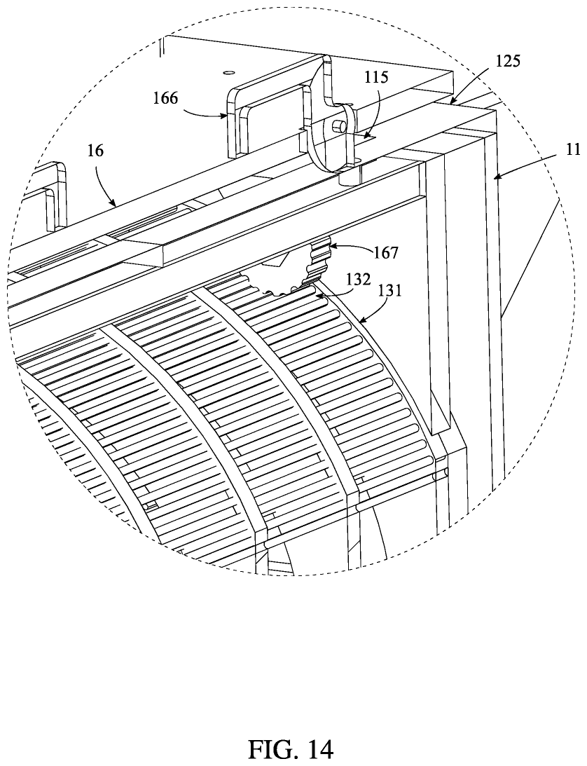

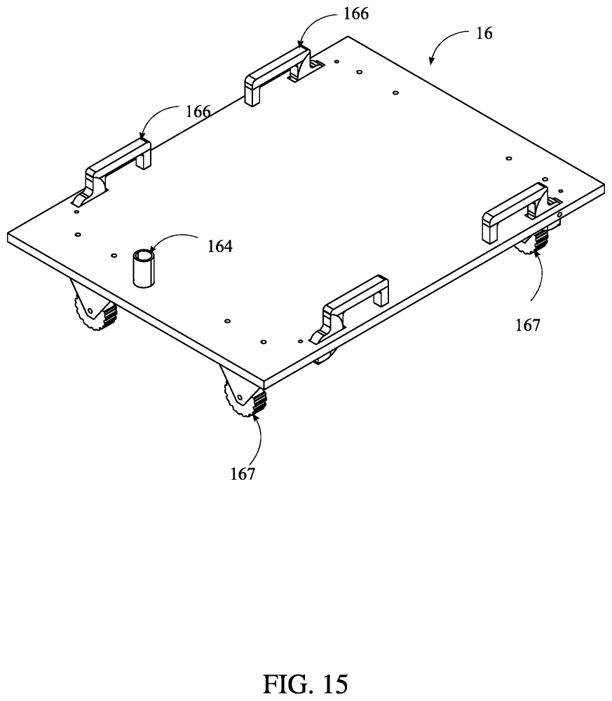

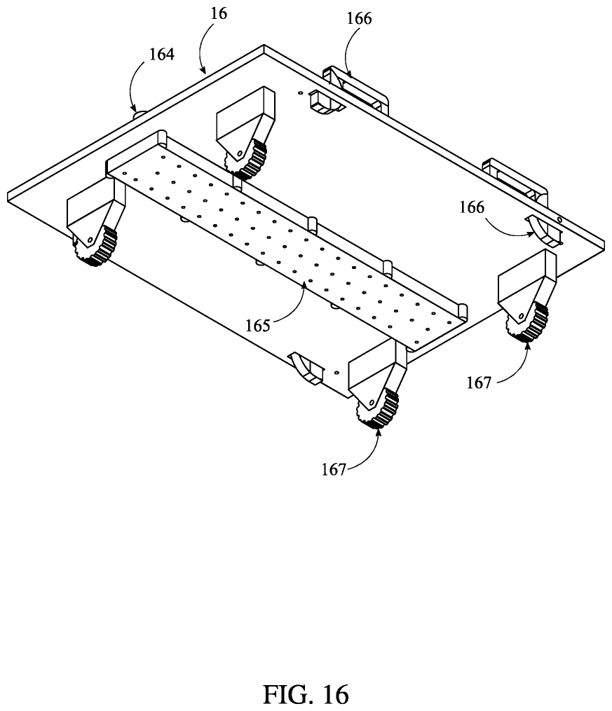

In the preferred embodiment, the tumbler chassis 11 further comprises a utility compartment 116, as shown in FIGS. 2 and 6. The utility compartment 116 traverses into the tumbler chassis 11. The motor 14 is positioned within the utility compartment 116. In the preferred embodiment, the utility compartment 116 secures and contains the motor 14 or any other suitable utility components such as but not limited to maintenance tools, cleaning supplies, or any other suitable utility item. In the preferred embodiment, the tumbler chassis 11 further comprises a utility access panel 117, as shown in FIGS. 1-6. The utility access panel 117 is delineated along the utility compartment 116. The utility access panel 117 is connected along the utility compartment 116. In the preferred embodiment, the utility access panel 117 serves as an openable access panel that covers and secures the utility compartment 116 along the tumbler chassis 11.

In the preferred embodiment the tumbler chassis 11 further comprises a catch compartment 118 and a catch receptacle 119, as shown in FIGS. 1, 3-4, and 6. The catch compartment 118 traverses into the tumbler chassis 11. The catch receptacle 119 is positioned within the catch compartment 118. In the preferred embodiment, the catch compartment 118 is oriented towards the cutting element 15 such that the ingredient refuse cuttings produced by the cutting element 15 are deposited towards the catch compartment 118. In the preferred embodiment, the catch receptacle 119 serves as a removable refuse bin that catches and stores ingredient refuse cuttings deposited towards the catch compartment 118.

In the preferred embodiment, the tumbler chassis 11 further comprises a catch access panel 121, as shown in FIGS. 1-6. The catch access panel 121 is delineated along the catch compartment 118. The catch access panel 121 is connected adjacent to the catch compartment 118. The catch access panel 121 serves as an openable access panel situated along the catch compartment 118.

In reference to FIGS. 1-4 and 6, the tumbler chassis 11 comprises an inlet channel 122 and an outlet channel 123. The inlet channel 122 traverses from the inlet hopper 113 to the tumbler drum 13. The outlet channel 123 traverses from the tumbler drum 13 to the outlet spout 114. The tumbler chassis 11 further comprises an outlet access panel 124, as shown in FIGS. 1-5. The outlet access panel 124 is delineated along the outlet channel 123. The outlet access panel 124 is connected along the outlet channel 123. In the preferred embodiment, the inlet channel 122 serves as the opening between the inlet hopper 113 and the tumbler drum 13 that guides unprocessed ingredients deposited in the inlet hopper 113 into the tumbler drum 13. In the preferred embodiment, the outlet channel 123 serves as the opening between the outlet spout 114 and the tumbler drum 13 that guides process ingredients from the tumbler drum 13 to the outlet spout 114. In the preferred embodiment, the outlet channel 123 also serves as an insertion port when the user is utilizing the multi-functional food processing machine 1 as a sauce tumbler or as an ingredient washer. In the preferred embodiment, the outlet access panel 124 serves as an openable access panel secured along the outlet spout 114. More specifically, the outlet access panel 124 closes off the tumbler drum 13 and prevents ingredients tumbling within the tumbler drum 13 from exiting prematurely.

In the preferred embodiment, the multi-functional food processing machine 1 further comprises a power supply 18, a processing unit 19, and a controller 21, as shown in FIG. 11. The processing unit 19 comprises a power input terminal 191, a signal input terminal 192, a first signal output terminal 193, and a second signal output terminal 194.

The motor 14, the vibration unit 17, the controller 21, and the power supply 18 are electronically connected to the processing unit 19. The power supply 18 is electrically connected to the power input terminal 191. The controller 21 is electronically connected to the signal input terminal 192. The motor 14 is electronically connected to the first signal output terminal 193. The vibration unit 17 is electronically connected to the second signal output terminal 194. In the preferred embodiment, the power supply 18 takes the form of any suitable power supply 18 such as but not limited to AC power supply 18, battery power supply 18, or any other suitable power supply 18 that powers the electrical components that constitutes the multi-functional food processing machine 1. In the preferred embodiment, the processing unit 19 takes the form of a CPU board that handles all electronic functions of the multi-functional food processing machine 1. In the preferred embodiment, the controller 21 serves as any suitable interface controller 21 that allows the user to control specified variable functions associated with the motor 14 or vibrator. Such specified variable functions include but are not limited to toggle power on/off, rotational speed RPM, vibration magnitude, customized spin motions, or any other suitable variable functions. In the preferred embodiment, the controller 21 comprises a timer 23. The timer 23 is electronically connected to the signal input terminal 192. The timer 23 allows the user to set the duration of time that the multi-functional food processing machine 1 operates. In the preferred embodiment, the power input terminal 191 directs power derived from the power supply 18 into the processing unit 19 such that the processing unit 19 regulates ample current to the first signal output terminal 193 and the second signal output terminal 194. The signal input terminal 192 relays user interface driven signals derived from the controller 21 to the processing unit 19 such that the processing unit 19 executes commands to the first signal output terminal 193 or second signal output terminal 194. The commands executed along the first signal output terminal 193 will manipulate the motor 14, while commands executed along the second signal output terminal 194 will manipulate the vibration unit 17.

In reference to FIGS. 12-16, the toolhead 16 further comprises a water inlet 164, a sprinkler 165, a plurality of engagement elements 166, and a plurality of vibration rollers 167. The water inlet 164 is connected adjacent to the toolhead 16. The sprinkler 165 traverses along the toolhead 16, opposite to the water inlet 164. The water inlet 164 and the sprinkler 165 being in fluid communication with each other. The plurality of engagement elements 166 is distributed about the toolhead 16. The plurality of vibration rollers 167 is distributed about the toolhead 16. The plurality of vibration rollers 167 is selectively engaged to the tumbler drum 131 through the plurality of engagement elements 166. In this embodiment, the toolhead 16 incorporates the washing unit, in addition to acting as the vibration unit for food media sifting functions. More specifically, the plurality of engagement elements 166 takes the form of any suitable engagement implement that allows the plurality of vibration rollers 167 to engage to the tumbler drum 131. In this embodiment, the plurality of engagement elements 166 takes the form of camming levers that raises or lowers the toolhead 16 along the upper receiver channel 115. Raising the toolhead 16 disengages the engagement of the plurality of vibration rollers 167 to the tumbler drum 131. Lowering the toolhead 16 allows the plurality of vibration rollers 167 to engage along the tumbler roller in order to vibrate the toolhead 16. In this embodiment, the plurality of vibration rollers 167 takes the form of any suitable vibration implement that vibrates the toolhead 16 while the tumbler drum 131 is in motion. In this embodiment, the plurality of vibration rollers 167 takes the form of rotary vibration gears the mesh along the tumbler drum 131, specifically along the plurality of gaps 132 such that the plurality of vibration roller is configured to vibrate the toolhead 16 in a vertical oscillating fashion suitable for sifting operations. In this instance, the user can place a separate sifting bowl along the top of the toolhead 16 where the vibrating toolhead 16 will provide ample vibration to the sifting bowl to remove excess breading or any other excess sifting media from the food article.

In reference to FIG. 13, the multi-functional food processing machine 1 further comprises a plurality of adjustment elements 22. The tumbler chassis 11 comprises a lower tumbler base 126 and an upper tumbler portion 125. The lower tumbler base 126 is positioned terminally opposite to the upper tumbler portion 125. The plurality of adjustment elements 22 is distributed about the lower tumbler base 126, where the plurality of adjustment elements 22 is configured to adjust the tumbler chassis 11 in a specified angle. In the preferred embodiment, the plurality of adjustment elements 22 takes the form of a plurality of adjustable casters but may take the form of any other suitable adjustment implement such as, but not limited to adjustment legs, tilt struts, or any other suitable adjustment implement. The plurality of adjustment elements 22 allows the user to adjust and raise the plurality of adjustment elements 22 situated along the inlet hopper 113 side, such that the tumbler drum 131 is oriented in the specified angle, where the unprocessed food media being fed into the inlet hopper 113 will easily feed into the tumbler drum 131. Additionally, the tilted orientation will aid in having the tumbled and processed food media to feed across the tumbler drum 131 and out of the outlet spout.

Although the invention has been explained in relation to its preferred embodiment, it is to be understood that many other possible modifications and variations can be made without departing from the spirit and scope of the invention as hereinafter claimed.

What is claimed is:

1. A multi-functional food processing machine comprising:
a tumbler chassis;
a tumbler drum;
a motor;
a cutting element;
the tumbler chassis comprising a tumbler track, a tumbler roller, an inlet hopper, and an outlet spout;
the tumbler drum comprising a drum cavity, a plurality of gaps, a plurality of tumbler fins, and a plurality of tumbler partitions;
the tumbler track being connected within the tumbler chassis;
the tumbler drum being rotatably connected to the tumbler track;
the tumbler roller being rotatably engaged to the tumbler drum;
the motor being torsionally engaged to the tumbler roller;
the drum cavity being positioned within the tumbler drum;
the plurality of gaps being peripherally distributed about the tumbler drum;
the plurality of tumbler fins being peripherally connected about the drum cavity;
the plurality of partitions being longitudinally distributed along the drum cavity;
the inlet hopper traversing from the tumbler chassis to the drum cavity;
the outlet spout traversing from the drum cavity to the tumbler chassis, opposite to the inlet hopper; and
the cutting element being operatively engaged to the tumbler drum, wherein the cutting element is configured to skim tangent along the plurality of gaps.

2. The multi-functional food processing machine as claimed in claim 1 comprising:
a power supply;
a processing unit;
a vibration unit;
a controller;
the processing unit comprising a power input terminal, a signal input terminal, a first signal output terminal, and a second signal output terminal;
the power supply being electrically connected to the power input terminal;
the controller being electronically connected to the signal input terminal;
the motor being electronically connected to the first signal output terminal; and
the vibration unit being electronically connected to the second signal output terminal.

3. The multi-functional food processing machine as claimed in claim 1 comprising:
the controller comprising a timer; and
the timer being electronically connected to the signal input terminal.

4. The multi-functional food processing machine as claimed in claim 1 comprising:
a toolhead;
the tumbler chassis comprising an upper receiver channel;
the upper receiver channel traversing from the tumbler chassis to the tumbler drum; and
the toolhead being connected along the upper receiver channel.

5. The multi-functional food processing machine as claimed in claim 4 comprising:
the toolhead further comprising a water inlet, a sprinkler, a plurality of engagement elements, and a plurality of vibration rollers;
the water inlet being connected adjacent to the toolhead;
the sprinkler traversing along the toolhead, opposite to the water inlet;
the water inlet and the sprinkler being in fluid communication with each other;
the plurality of engagement elements being distributed about the toolhead;
the plurality of vibration rollers being distributed about the toolhead; and
the plurality of vibration rollers being selectively engaged to the tumbler drum through the plurality of engagement elements.

6. The multi-functional food processing machine as claimed in claim 4 comprising:
the toolhead is a sifting tray;
the sifting tray comprising a sift channel and a sifting screen;
the sift channel traversing through the sifting tray; and
the sifting screen being delineated along the sift channel.

7. The multi-functional food processing machine as claimed in claim 6 comprising:
a vibration unit; and
the vibration unit being operatively engaged to the tumbler chassis, wherein the vibration unit is configured to transmit vibration to the sifting tray.

8. The multi-functional food processing machine as claimed in claim 4 comprising:
the toolhead is a washing unit;
the washing unit comprising a mounting surface, a water inlet and a sprinkler;
the mounting surface traversing along the toolhead;
the sprinkler traversing along the mounting surface;
the water inlet being connected adjacent to the toolhead; and
the water inlet being in fluid communication with the sprinkler.

9. The multi-functional food processing machine as claimed in claim 1 comprising:
the tumbler chassis further comprising a utility compartment;
the utility compartment traversing into the tumbler chassis; and
the motor being positioned within the utility compartment.

10. The multi-functional food processing machine as claimed in claim 1 comprising:
the tumbler chassis further comprising a utility access panel;
the utility access panel being delineated along the utility compartment; and
the utility access panel being connected along the utility compartment.

11. The multi-functional food processing machine as claimed in claim 1 comprising:
the tumbler chassis further comprising a catch compartment and a catch receptacle;
the catch compartment traversing into the tumbler chassis; and
the catch receptacle being positioned within the catch compartment.

12. The multi-functional food processing machine as claimed in claim 10 comprising:
the tumbler chassis further comprising a catch access panel;
the catch access panel being delineated along the catch compartment; and
the catch access panel being connected adjacent to the catch compartment.

13. The multi-functional food processing machine as claimed in claim 1 comprising:
the tumbler chassis further comprising an inlet channel and an outlet channel;
the inlet channel traversing from the inlet hopper to the tumbler drum; and
the outlet channel traversing from the tumbler drum to the outlet spout.

14. The multi-functional food processing machine as claimed in claim 12 comprising:
the tumbler chassis further comprising an outlet access panel;
the outlet access panel being delineated along the outlet channel; and
the outlet access panel being connected along the outlet channel.

15. The multi-functional food processing machine as claimed in claim 1 comprising:
a plurality of adjustment elements;
the tumbler chassis further comprising a lower tumbler base and an upper tumbler portion;
the lower tumbler base being positioned terminally opposite to the upper tumbler portion;
the plurality of adjustment elements being distributed about the lower tumbler base, wherein the plurality of adjustment elements is configured to adjust the tumbler chassis in a specified angle.

16. The multi-functional food processing machine as claimed in claim 1, wherein the plurality of adjustment elements is a plurality of adjustable casters.
